(19) United States
(12) Patent Application Publication
(10) Pub. No.: US 2025/0315618 A1
(43) Pub. Date: Oct. 9, 2025

(54) GROUNDING AUTOMATICALLY-GENERATED RESPONSES PRODUCED BY A Q&A SYSTEM

(71) Applicant: Oracle International Corporation, Redwood Shores, CA (US)

(72) Inventors: Sergio Aldea Lopez, Valladolid (ES); Oleg Gennadievich Shevelev, Chislehurst (GB); Pietro Giuseppe Di Stefano, London (GB); Matthew Charles Rowe, Milton Keynes (GB); Sahil Malhotra, Hampton (GB); Hugo Alexandre Pereira Monteiro, London (GB); Ahmad Noman, Reading (GB); Alberto Polleri, London (GB)

(21) Appl. No.: 18/629,898

(22) Filed: Apr. 8, 2024

(51) Int. Cl. G06F 40/279; G06F 16/3329; G06F 40/253

(52) U.S. Cl. CPC G06F 40/279; G06F 16/33295; G06F 40/253

(57) ABSTRACT

Techniques for grounding automatically-generated responses produced by a question-and-answer system are provided. In one technique, a list of items and introductory text that is associated with the list of items are identified within text data. For each item in the list of items, a claim that is based on the introductory text and said each item is generated and the claim is added to a set of claims that is associated with the text data. For each claim in the set of claims, a score that reflects a level of support of said each claim in a set of documents is generated and the score is added to a set of scores for the set of claims. Data that is based on the set of scores is presented on a screen of a computing device.

### TECHNICAL FIELD

The present disclosure generally relates to question-and-answer computer systems and, more particularly, to grounding output that is generated by question-and-answer computer systems.

### BACKGROUND

In recent years, the advent of Large Language Models (LLMs) has revolutionized various tasks, including Question and Answering (Q&A) tasks. These models, with their ability to understand and generate human-like text, have shown remarkable performance in understanding information, and providing relevant responses based on that information. However, despite their impressive capabilities, they bring about some challenges.

In the context of Q&A tasks, an LLM can be used to generate responses to specific queries. An LLM can be trained with a large corpora that contains generic information about most current human knowledge and make use of the corpora to reply to questions. Similarly, an LLM can also be trained on a very specific set of documents of a given domain, e.g. medical data, to offer detailed answers to specific questions in such a domain.

One of the most significant issues that has emerged in these scenarios is the problem of “hallucinations.” Hallucinations, in the context of LLMs, refer to instances where an LMM generates sequences of text that are not grounded in the input training data or factual reality. This can lead to the generation of misleading or entirely false information, posing a serious concern for the reliability and trustworthiness of these models.

To enhance the performance of a Q&A system and mitigate the issue of hallucinations, one common approach is to connect the Q&A system to a knowledge base (KB). A knowledge base is a structured database of information that the Q&A system can retrieve to provide more accurate and potentially more reliable responses. Such a KB allows the system to retrieve the most relevant facts to a given question and include them in the input (prompt) that it is sent to an LLM. In other words, instead of letting an LLM come up with a response on its own based on the information that is encoded in its weights after the training process, the LLM is given, as part of the prompt, both the question and relatively short piece of information (e.g., up to a few pages) to answer to the question. By doing this, the LLM is conditioned to generate a more grounded response, potentially reducing the issue of hallucinations.

However, LLMs do not always adhere to the provided material, and hallucinations can still happen, and therefore this issue underscores the need for metrics that enable the detection of hallucinations and signal how well a response is grounded in the provided information.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system architecture for automatically evaluating responses that were automatically generated by a Q&A system, in an embodiment;

FIG. 2 is a flow diagram that depicts an example process for processing claims in a text response, in an embodiment;

FIG. 3 is a flow diagram that depicts an example process for processing evidence relative to a text response, in an embodiment;

FIG. 4 is a block diagram that depicts an example scenario where two claims are scored relative to multiple pieces of evidence, in an embodiment;

FIG. 5 is a block diagram that illustrates a computer system upon which an embodiment of the invention may be implemented;

FIG. 6 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for automatically evaluating how well responses given by a Question and Answering (Q&A) system (e.g., based on Large Language Models (LLMs)) are grounded in a specific set of reference documents. LLMs are prone to generating hallucinations, which are sequences of text that are factually incorrect or not substantiated by the training data. Embodiments allow for a fine-grained, sub-sentence identification of these hallucinations, and generate a set of tangible and interpretable metrics that are easily actionable by decision-makers. This set of metrics can also be used to aid data labelling tasks, e.g., labelling the responses of an LLM as grounded or ungrounded. This set of metrics allows for the online evaluation of applications built using LLMs, including but not limited to Q&A systems, chatbots, etc., without the need for generating an evaluation dataset and/or ground truth expected responses.

Embodiments ground claims whose content is spread across different and independent pieces of evidence. Additionally, embodiments generate metrics (i.e., sufficiency and truthfulness) that can be used to evaluate the factual consistency of the responses in the absence of retrieved documents, against ground truth expected responses and sources of information. Finally, embodiments avoid the usual false negatives of prior approaches when the claims do not contain any relevant information, such as probing questions and fillers.

### System Overview

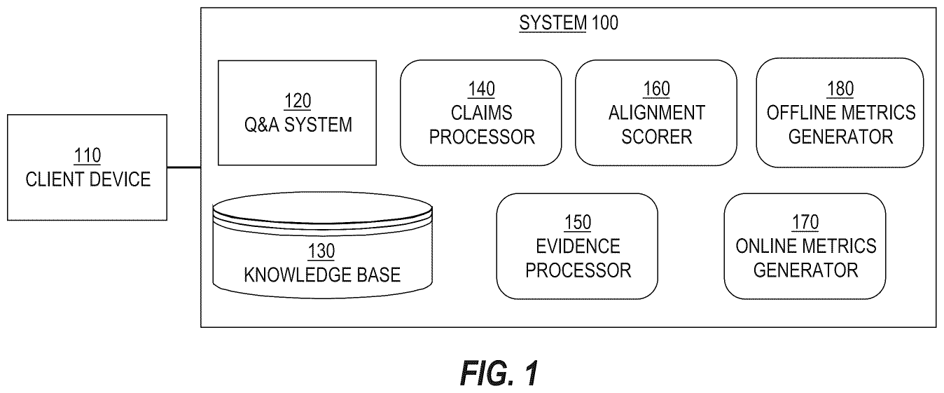

FIG. 1 is a block diagram that depicts an example a response generation and scoring system 100 for automatically evaluating responses that were automatically generated by a Q&A system, in an embodiment. System architecture 100 comprises a Q&A system 120, a knowledge base 130, a claims processor 140, an evidence processor 150, an alignment scorer 160, an online metrics generator 170, and an offline metrics generator 180. Each of Q&A system 120, claim processor 140, evidence processor 150, alignment scorer 160, online metrics generator 170, and offline metrics generator 180 may be implemented in software, hardware, or any combination of software and hardware.

Client device 110 may be a desktop computer, a laptop computer, a tablet computer, a smartphone, a wearable device, or any other computing device that is capable of transmitting a request to system 100 or Q&A system 120. Such transmission may be made over a computer network, such as a local area network (LAN), a wide area network (WAN), or the Internet. Client device 110 may include a screen that displays a result of a request (that includes a prompt) that is transmitted to system 100 or Q&A system 120, such as one or more statements or claims that Q&A system 120 output based on the request. The displayed result, as described in more detail herein, may also include evaluation data that indicates whether the set of claims as a whole is grounded and/or whether each claim in the set of claims is grounded. While only a single client device is depicted, system 100 may be communicatively coupled to multiple client devices over one or more computer networks.

Q&A system 120 receives input from client device 110 and generates output based on the input. The input comprises a prompt in the form of a question or a request for information. Q&A system 120 may comprise one or more LLMs, but embodiments are not limited to an LLM-based approach. Q&A system 120 is connected to knowledge base 130. Knowledge base 130 may be implemented as one or more databases of textual information. Examples of items stored in knowledge base 130 include documents and any type of file (e.g., images, audio, video), each of which may be associated with metadata that describes the corresponding item.

As an example of an implementation of Q&A system 120 is where the generation of responses follows a Retrieval-Augmented Generation (RAG) pattern. The RAG pattern involves two steps: (a) retrieval of relevant documents from KB 130, and (b) generation of responses based on both the retrieved documents and the original prompt or query. An advantage of this pattern is that Q&A system 120 is able to leverage the specific information in KB 130 while maintaining the ability to generate fluent and contextually appropriate responses. However, embodiments may be applied to any combination of claim(s) vs. evidence(s), where the claims are not necessarily generated by Q&A system 120, and the pieces of evidence do not necessarily come from KB 130.

The output or response from Q&A system 120 comprises one or more claims. The output may be one or more formats, such as a string of complete sentences, a partial sentence with bullet points, a list, etc. Output may be delimited by periods, commas, semi-colons, colons, or any combination thereof. For example, an instance of output may be five complete sentences or may be one complete sentence and a phrase following by a set of bullet points that are delimited by semi-colons.

### Claims Processor

Claims processor 140 processes or analyzes output that Q&A system 120 generates based on input from client device 110. Claims processor 140 identifies one or more claims found within the output and may modify or augment the output with additional text.

One approach for processing output from Q&A system 120 is to split the output into sentences in a naïve way, i.e., by only considering the separation given between sentences by a period, without any extra processing or consideration. However, this approach does not respect the semantics of the text, which can potentially lead to sentences that are impossible to correctly evaluate for grounding purposes.

Embodiments involve implementing one or more of the following techniques: pronoun co-referencing, list processing, filler processing, and second person sentence extension.

Regarding pronoun co-referencing, a claim in output from Q&A system 120 might refer to an earlier claim through pronouns. Generating a grounding score for such a claim would be irrelevant if the scoring model does not know to which entity the pronoun refers. If the claim is considered independently from the referencing sentence, then it is not possible to establish, with a high degree of certainty, the grounding of the claim. An example of a claim block (i.e., a set of claims) that includes a claim that includes a pronoun is as follows: “A good diet includes starchy and non-starchy vegetables. Starchy foods include corn and potatoes. These contain a high amount of carbohydrates.” If this claim block is broken into individual claims (e.g., by sentence), then it is not clear how to correctly determine the grounding of the last claim (which includes the word “These”), since the last claim, when compared against an evidence block, could refer to any food. Therefore, in an embodiment, before breaking a claim block into individual sentences or claims, pronouns are identified and replaced with the nouns to which the pronouns refer. In the above example, the last claim would be amended to read the following, “Starchy foods contain a high amount of carbohydrates.” After a claim with a pronoun is updated to replace the pronoun with one or more nouns, the updated claim is compared against an evidence block.

Regarding list processing, a naïve approach to identifying claims in a list that comprises multiple items (or elements) (e.g., delineated by bullet points) is to consider each item as a separate claim. However, it may not be possible to establish the grounding of each item when evaluated in isolation. In other words, single items are not claims and, therefore, should be handled differently. Each item in a list can positively or negatively affect a response on whether the item is grounded, depending on how the list was introduced, and it is not possible to know if the item is only evaluated independently.

In an embodiment, each item in a list is assigned to an independent claim, but the item is also prepended to the portion of the sentence that introduces the list. For example, a list may be the following:

To qualify for the certificate, students must:
submit a Certificate Form of Intent
attend at least 80 percent of the classes
achieve a “Pass” designation in coursework from the instructors
submit a Certificate Request Form after all requirements have been met
submit a Professional Certificate Program Survey

In this example, the introduction is “To qualify for the certificate, students must:”. Examples of constructed sentences include: “To qualify for the certificate, students must submit a Certificate Form of Intent”; “To qualify for the certificate, students must attend at least 80 percent of the classes”; “To qualify for the certificate, students must achieve a ‘Pass’ designation in coursework from the instructors”; etc. Thus, when constructing sentences, the colon in the introduction is removed, along with the bullets that precede the items. While this example involves bullet points, embodiments are not so limited. Embodiments are also able to process lists where the items are delimited by other characters or icons, such as numbers. Prior approaches that analyzed numbered lists recognize a number and a period (e.g., “1.”) and treat them as a single claim, which results in a low score for the overall response that included that number. Embodiments, on the other hand, identify such numbers and remove such numbers from consideration as a claim or part of a claim.

This approach for generating sentences as claims produces two advantages: (1) each item is semantically linked with the context that introduces that item, and (2) hallucinations in individual items in a list are able to be found, providing a much more fine-grained evaluation. This latter advantage is of particular importance when using LLMs to generate text, as LLMs are more prone to introduce hallucinations when they start generating an enumeration of elements.

Claims processor 140 automatically identifies a list based on one or more heuristic rules and/or based on a machine-learned classifier. A block of text may be identified as containing a list based on one or more factors, such as having multiple bullet points in a single sentence, multiple numbers in a single sentence, and/or multiple carriage returns in a single sentence.

In some situations, a block of text contains sentences that implicitly enumerate a number of items, conditions, etc., without the use of explicit bullet points or numbers. Such a list is referred to a “flattened list.” Flattened lists suffer from the same issue as described above: LLMs are more prone to introducing hallucinations into such lists. Thus, in a related embodiment, flattened enumerations are identified and broken down into independent claims with the first part of the sentence appended to them. The identification step may be implemented with a heuristic where sentences that include several comma-separated (or semi-colon-separated) short pieces are considered as flattened lists. To mitigate the risk of incorrectly identifying regular sentences with commas (false positives), a minimum number of pieces (or commas) is set as parameterizable threshold.

Regarding filler processing, a block of text produced by a Q&A system may contain connecting sentences that do not have any valuable content but are required to construct a human-like response. Typically, this type of sentence is not grounded in the evidence. For example, a response may contain one or more of the following sentences: “Sure!”, “No problem”, or “Would you like to know more about this?” If one of these sentences was evaluated as a claim, then it would likely have a low score, which would bring down the overall score for an entire response. However, such a lower overall score for the entire response would not be correct.

Therefore, in an embodiment, claims processor 140 (or another component of system architecture 100) automatically identifies filler sentences. Such identification may involve considering sentence length (e.g., less than four words) and/or comparing a candidate sentence against one or more sentences in a dictionary that includes the most common fillers in the context of a Q&A system. In a related embodiment, a machine-learned model is trained (using one or more machine learning techniques) to identify filler sentences based on positive training samples (including known filler sentences) and, optionally, negative training samples (including known sentences that are not filler sentences).

Regarding second person sentence extension, some sentences in blocks of text, when taken in isolation, do not have grounding. For example, the sentence “Yes, you may have <condition>” does not have real grounding since it lacks the connection to why the person would have the condition. Such sentences are referred to as “second person sentences” because they refer to the prompter and/or they imply the existence of information that is not contained in the sentence and the information is implied in an earlier exchange of information between the user and the system.

Therefore, in an embodiment, claims processor 140 automatically identifies second person sentences in a block of text and combines a second person sentence with at least a portion of the prompt that caused the second person sentence to be generated. Identification of second person sentences may be using hard-coded rules or heuristics. Alternatively, such identification may be performed with a machine-learned model that is trained to identify second person sentences. An example of a question and an answer that is identified as a second person sentence is the following:
Q: Why is my throat sore?
A: You may have tonsillitis.

An example of a combination of the question and answer is the following: Your throat may be sore because you have tonsillitis.

A machine-learned model may be used to correctly combine the question and the second person sentence, generating rephrased versions of the problematic sentences.

### Evidence Processor

Evidence processor 150 processes one or more documents that have been retrieved and included in a prompt from which Q&A system 120 generates the response that is being grounded. In the context of the RAG pattern, each retrieved document is potentially independent from each other. Each retrieved document may cover the response as whole, only partially, or even mention different concepts to the ones contained in the response. However, prior approaches evaluating each document (or “block of evidence”) independently for the whole block of claims. Such approaches produce low scores when a claim in a response is spread across different retrieved documents.

Therefore, in an embodiment, evidence processor 150 generates one or more pieces of evidence, concatenating multiple documents into a single document. In this way, it is more likely that a concatenated block of pieces of evidence contains all the information that potentially supports the response. For example, if Q&A system 120 relied on three documents (i.e., D1, D2, D3) from KB 130 to generate a response, then evidence processor 150 may generate three additional pieces of evidence: {D1, D2}, {D1, D3}, and {D1, D2, D3}.

However, some Q&A systems have input length limits. Thus, combining multiple documents into one concatenated document is more likely to cause the input length limit to be reached. When this limit is reached, typical Q&A systems break evidence blocks into token chunks of a certain size, such as 350 tokens per chunk. Consequently, any particular retrieved document may be split into two independent blocks, which defeats the purpose of alignment, as the broken sentences may not have the correct semantics. More importantly, such splitting renders the concatenation of different documents useless to solve the problem of having a claim spread across different chunks.

For example, if a claim C is partially supported by a document D1 that falls in the evidence chunk E1, while there are claim parts that are supported by another document D2 that falls in another evidence chunk E2, then the final score will be irreversibly low. This problem is aggravated if the claim is supported by non-consecutively-retrieved documents, which makes it more likely that the documents fall into different evidence chunks.

When the concatenation of retrieved documents is longer than the limit imposed by Q&A system 120, embodiments involve evidence processor 150 generating a series of different combinations of concatenated retrieved documents. In this way, the probability that a concatenated evidence chunk contains the information required to back up a claim is maximized. One way to identify all the groups of concatenated retrieved documents is as follows.

First, identify the set of N retrieved documents (i.e., that was used to generate the response in the embodiment where Q&A system 120 included the set of N retrieved documents as input). Second, determine whether the total size of the set of N retrieved documents exceeds the input token limit. If not, then the set of N retrieved documents is put into a VALID_COMBINATIONS set and the process proceeds to step seven. Otherwise, the set of N retrieved documents are put into an OVER_THE_LIMIT set and the process proceeds to step 3.

Third, a combination from the OVER_THE_LIMIT set is made the current combination. Fourth, each document in the current combination with an individual score of zero is removed from the current combination, creating a new combination. If the new combination is still over the limit or no document was removed (e.g., because no document has a score of zero), then multiple new combinations are created by removing one of the documents in the current combination, i.e., by removing only the first document, the first new combination is created, by removing only the second document, the second new combination is created, etc. The goal is to create all possible combinations, where the number of documents in a new combination is only one less than the number of documents in the current combination.

Fifth, each new combination is moved into one of the two sets, i.e., the OVER_THE_LIMIT set or the VALID_COMBINATIONS set. If a new combination is over the limit, then that new combination is added to the OVER_THE_LIMIT set, otherwise that new combination is added to the VALID_COMBINATIONS set. If a new combination is already in the VALID_COMBINATIONS set, then the new combination is not added again. In other words, there are no duplicate combinations in the VALID_COMBINATIONS set. Sixth, the proceed returns to the third step until there are no combinations remaining in the OVER_THE_LIMIT set.

Seventh, each combination in the VALID_COMBINATION set is used for checking for evidence. In other words, each combination in the VALID_COMBINATION is used to generate an alignment score for a claim.

For example, if there are four retrieved documents [A, B, C, D], where any combination of more than three documents goes over a token limit, the following groupings may be generated.

1. [{A, C, D}, {B}]
2. [{D}, {A, B, C}]
3. [{C}, {A, B, D}]
4. [{B, C, D}, {A}]

All the unique subgroups in the previous list are added as additional evidence blocks to be considered for the next step. The above seven step process may be shortened if one or more alignment scores are generated for each combination when that combination is added to the VALID_COMBINATION set and the generated alignment score is compared to a threshold score. If an alignment score for a claim exceeds the threshold score, then the claim may be considered sufficiently grounded and the process may stop, at least for that claim.

In another example, if all the four retrieved documents can be concatenated into one single piece of evidence without breaking the input token limit, only one additional evidence block will be added to the list of individual documents.

While the calculation of all the different scores can explode quickly with the number of retrieved documents, in practice there are two factors that make this computation feasible: it is possible to get all the scores in parallel (meaning there will be multiple instances or replicas of alignment scorer 160, since each is independent and immutable), and the number of retrieved documents is usually kept at the minimum required to answer the question, which reduces both the final number of combinations and the noise in the context injected in the input prompt.

### Alignment Scorer

Alignment scorer 160 calculates a factual consistency between each claim and each piece of evidence. An example of such calculation is using a fine-tuned version of a RoBERTa model, though embodiments are not so limited. Another machine-learned model that returns equivalent outputs may be used, whether a third-party model or a proprietary version. Alignment scorer 160 computes a collection of scores in a continuous range, such as between 0 and 1 or 0 and 100. For example, if there are five claims and six pieces of evidence, then alignment scorer 160 computes thirty scores.

### Example Process: Claims Processing

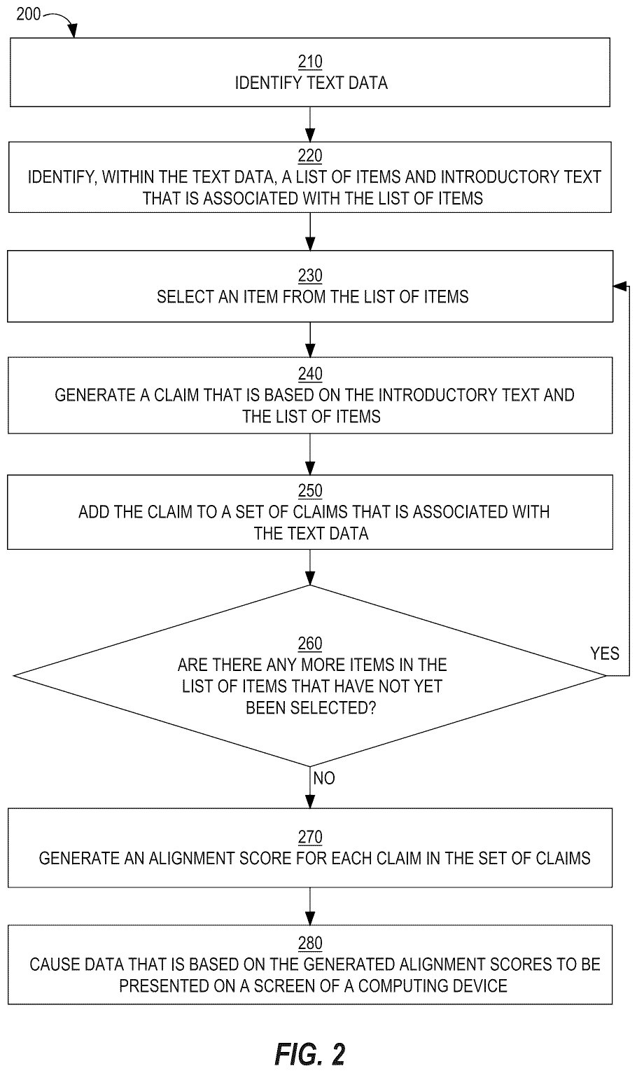

FIG. 2 is a flow diagram that depicts an example process 200 for processing claims in a text response, in an embodiment. Process 200 may be performed by different components of system architecture 100.

At block 210, text data is identified. The text data may be output from a Q&A computer system, such as Q&A system 120. The text data may be the result of inputting a text prompt into a LLM. The text data may comprise multiple sentences. Block 210 may be performed by claims processor 140.

At block 220, a list of items and introductory text that is associated with the list of items are identified within the text data. Block 220 may involve identifying multiple sentences and, for one of the sentences, determining that the sentence lists multiple items. Each item is a series of one or more words or phrases. The multiple items may be separated by commas, semi-colons, carriage returns, numbers, or bullet points. Block 220 may be performed by claims processor 140.

At block 230, an item from the list of items is selected. The selection may be random. Alternatively, block 230 may involve selecting the item that is at the head of the list of items. Thus, in the first iteration of block 230, the first item in the list of items is selected; in the second iteration of block 230, the second item in the list of items is selected; and so forth. Block 230 may be performed by claims processor 140.

At block 240, a claim that is based on the introductory text and the selected item is generated. Block 240 may involve appending the selected item to the introductory text. Block 240 may be performed by claims processor 140.

At block 250, the generated claim is added to a set of claims that is associated with the text data. Initially, before the first iteration of block 250, the set of claims is empty. After the first iteration of block 250 (and before the second iteration thereof), the set of claims comprises only a single claim. Block 250 may be performed by claims processor 140.

At block 260, it is determined whether there are any more items in the list of items that has not yet been selected. If so, then process 200 returns to block 230. Otherwise, process 200 proceeds to block 270. Block 260 may be performed by claims processor 140.

At block 270, an alignment score is generated for each claim in the set of claims. An alignment score reflects a level of support that a set of documents has for the claim that corresponds to the alignment score. The set of documents comprises documents that may have been used by Q&A system 120 to generate the text data identified or accessed in block 210. Block 270 may be performed by alignment scorer 160.

At block 280, data that is based on the generated alignment scores caused to be presented on a screen of a computing device. Block 280 may involve sending the data over one or more computer networks to client device 110. The data may include the alignment scores generated in block 270. Additionally or alternatively, the data may be an average score of the alignment scores generated in block 270.

### Example Process: Evidence Processing

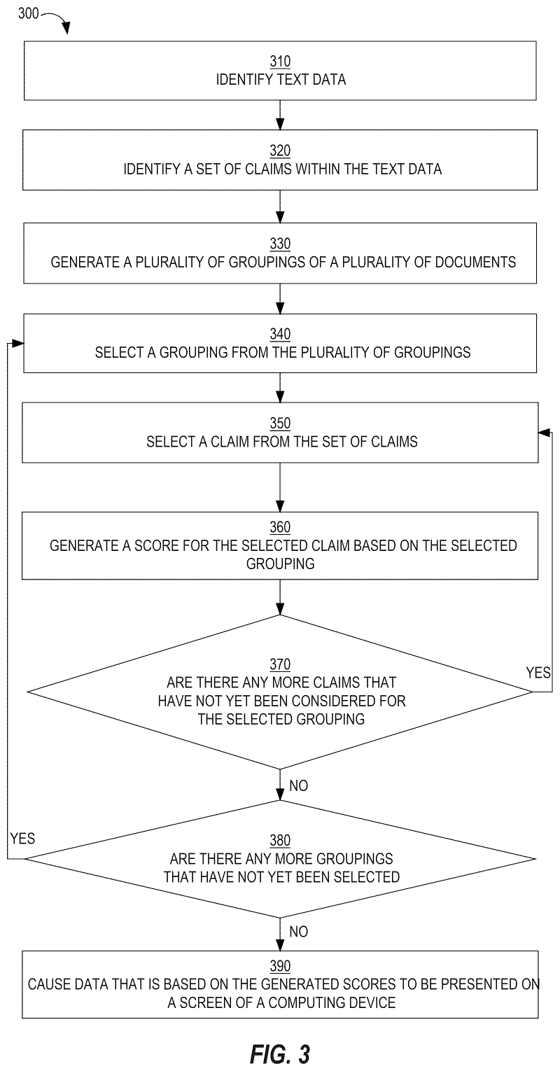

FIG. 3 is a flow diagram that depicts an example process 300 for processing evidence relative to a text response, in an embodiment. Process 300 may be performed by different components of system architecture 100.

At block 310, text data is identified. The text data may be output or generated by a Q&A computer system based on a prompt and a plurality of documents that were input to the Q&A computer system.

At block 320, a set of claims is identified within the text data. Block 320 may be performed by claims processor 140.

At block 330, a plurality of groupings of a plurality of documents is generated. The plurality of documents may have been input upon which the set of claims is based if the set of claims was generated by a computer system, such as Q&A system 120. Each grouping divides the plurality of documents differently. For example, if there are three documents in the plurality of documents, then groupings may be ({A, B}, {C}), ({A}, {B, C}), ({A, C}, {B}), and ({A, B, C}). In this example, there are seven groupings. Block 330 may be performed by evidence processor 150.

At block 340, a grouping in the plurality of groupings is selected. Block 340 may be performed randomly or in a particular order. Block 340 may be performed by alignment scorer 160. For each execution of process 300, a grouping is only selected once.

At block 350, a claim in the set of claims is selected. Block 350 may be performed randomly or in a particular order, such as the order in which the claim is located in the text data. Block 350 may be performed by alignment scorer 160.

At block 360, a score is generated for the claim, where the score reflects a level of support of the selected claim in the selected grouping. Block 360 may be performed by alignment scorer 160. Block 360 may be performed by comparing the claim to the document(s) in the selected grouping.

At block 370, it is determined whether there are any more claims that have not been considered for the selected grouping. If so, then process 300 returns to block 350 where another claim is selected. Otherwise, process 300 proceeds to block 380.

At block 380, it is determined whether there are any more groupings that have not yet been selected. If so, then process 300 returns to block 340 where another grouping is selected. Otherwise, process 300 proceeds to block 390.

In a related embodiment, instead of blocks 340 and 350, process 300 is performed only with respect to a single combination of the plurality of documents, such as all of the documents in the plurality or a strict subset of the plurality of documents.

At block 390, data that is based on the generated scores is caused to be presented on a screen of a computing device. For example, the data includes an aggregated score from the generated scores, such as minimum, maximum, mean, median, and percentile.

### Online Metrics Generator

In an embodiment, system architecture 100 includes an online metrics generator 170 that determines, for each claim and/or for each group of claims, whether the claim or group of claims is grounded. Online metrics generator 170 also generates a score for each metric of one or more metrics. Some metrics are claim-specific while other metrics are response-specific. (A response may comprise multiple claims). Therefore, a response may be associated with multiple scores: one or more response-level scores and multiple claim-level scores. This allows a user to view a response's overall score and, if moderate or low, which claim(s) is/are causing the response's overall score to moderate/low. For example, a response has a moderate score and has eight claims, seven of which have high scores (indicating that the corresponding claims are well grounded). However, one of the eight claims has a very low score, which has a large effect on the overall score.

Regarding grounding logic, online metrics generator 170 determines that a claim is grounded if the claim has at least one piece of evidence (or a combination of pieces of evidence) that grounds/supports the claim. In other words, the grounding of each claim is considered independently against each retrieved document and concatenated combination of documents. To determine whether a given claim is grounded on a given piece of evidence, the maximum value of the claim against any piece of evidence (or combination of pieces of evidence) is computed. For example, if there are six pieces of evidence, then alignment scorer 160 generates six scores for a particular claim. The maximum score of the six scores is identified and used as the alignment score for the particular claim.

In an embodiment, online metrics generator 170 uses a mapping function to map a claim's alignment score to a discrete grounding label for the claim. For example, the mapping function may assign one of three labels [“ungrounded”, “unclear”, and “grounded” ] to a claim using the following decision intervals [0.0, 0.4), [0.4, 0.6), and [0.6, 1.0]. The mapping function may use a different number of labels (e.g., two labels or four labels) and/or different decision intervals. A discrete label, rather than a continuous grounding score, is more interpretable by a non-technical person, which makes this metric a better candidate to be shown to users of Q&A system 120, if required, or to be actionable by a decision-maker.

In a related embodiment, the mapping function is configurable, meaning the labels and/or decision intervals dynamically change. For example, one or more machine learning techniques may be used to identify what the thresholds (that separate each discrete value) should be.

In an embodiment, once a grounding score and a label have been assigned to each claim of a response, online metrics generator 170 computes a set of metrics for the response, which comprises a block or set of claims. Example metrics include a response's grounding score, a response's mean grounding score, a response's grounding label, and a response's grounding percentage.

Regarding a response's grounding score, this score is the minimum alignment score score among all the claims in the response. This grounding score may be prioritized over a response's mean score because it may be considered that a set of claims is only as good as the minimum alignment score among that set of claims.

Regarding a response's mean grounding score, if computed, this score is the mean alignment score of all the claims in the response.

Regarding a response's grounding label, this label is the label that is determined based on the response's grounding score, which is the minimum grounding score of all claims in the response. The mapping function described herein may be used to translate or map a grounding score to a label.

Regarding a response's grounding percentage, online metrics generator 170 determines a grounding label for each claim of the response and computes a percentage of the claims of the response that are grounded. For example, if one claim of four claims in a response has a “grounded” label, then the response's grounding percentage is 25%.

In an embodiment, one or more of these grounding metrics is used in production to track the quality of responses that Q&A system 120 generates with respect to the retrieved documents for each question. Consequently, there is no need to generate an evaluation dataset with ground truth (expected) responses to be able to use these metrics.

In an embodiment, one or more grounding scores for a generated response are presented on a screen of a computing device, such as client device 110. For example, all of these four grounding metrics may be presented along with the generated response. A grounding score (or a set of grounding scores) may be presented in one or more ways, such as a list. A grounding score, if presented in a user interface, may be selectable, either via a touchscreen or via a cursor control device, such as a touchpad or a mouse. Selecting a grounding score may cause multiple claim scores to be presented. Also, selecting a grounding score for a generated response and/or selecting a claim score may cause multiple portions of the generated response to be highlighted. For example, selecting a grounding score for a response causes multiple claims scores to be presented and different portions of the grounding score to be highlighted based on the claims scores. For example, a claim that has a grounded label or score may be highlighted green, a claim that has an unclear label or score may be highlighted yellow, and a claim that has an ungrounded label or score may be highlighted red.

### Grounding Score Example

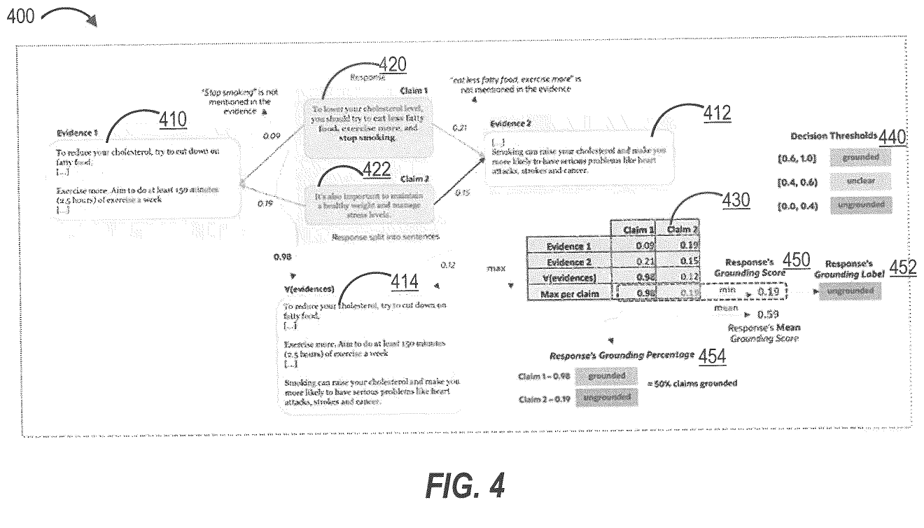

FIG. 4 is a block diagram that depicts an example scenario 400 where two claims are scored relative to multiple pieces of evidence, in an embodiment. Scenario 400 comprises pieces of evidence 410 and 412 that may have been input to a question and answer computer system, such as Q&A system 120. That same computer system may have generated a response that comprises claims 420 and 422. Thus, claims 420 and 422 may have been automatically generated based on an analysis of pieces of evidence 410 and 412.

Alignment scorer 160 generates a score measuring the alignment between each claim and each piece of evidence. Evidence processor 150 identifies pieces of evidence 410 and 412 and also generates a combination of the two pieces of evidence, which combination becomes evidence 414. Therefore, alignment scorer 160 also generates a grounding score between each claim and evidence 414. The grounding scores (which are between 0 and 1) are depicted in table 430, which comprises two scoring columns (that correspond to claims 420 and 422) and four scoring rows (three of which correspond to evidences 410-414, and one of which corresponds to an aggregate score, which, in this example, is a maximum score). Scores closer to 1 indicate a high level of support by the corresponding piece of evidence, whereas scores closer to 0 indicate a low level of support by the corresponding piece of evidence.

A grounding score 450 for the response is the minimum of the maximum scores of the individual claims. The maximum scores of the individual claims are 0.98 and 0.19. Therefore, the grounding score 450 for the response is 0.19, which, according to decision thresholds 440, is within the “ungrounded” range of 0 and 0.4. As a result, the grounding label 452 of the response is “ungrounded.” Also, the grounding percentage 454 of the response is 50%, since half of the claims are considered “grounded.”

### Offline Metrics Generator

The set of metrics that online metrics generator 170 generates allows for tracking the quality of the responses of Q&A system 120 (or other source of responses) without the need of an evaluation dataset. However, it is a recommended practice to evaluate such response sources with carefully crafted evaluation datasets, with the goal of assessing the quality of a response source before setting the response source up online. The set of metrics generated by online metrics generator 170 may also be used for this purpose, but the availability of ground truth responses and expected retrieved documents opens the room for the creation of new metrics.

In an embodiment, system architecture 100 includes an offline metrics generator 180 that generates one or more additional metrics that reflect the performance of a response generation system, such as Q&A system 120. These metrics are referred to as sufficiency and truthfulness.

The sufficiency metric signals how much content of a ground truth (or expected) response is actually included in a generated (or predicted) response. In other words, whatever is stated in the expected response is also included in the generated response. This metric is computed as the grounding score between the ground truth response and the generated response during evaluation. For the computation of this metric, the roles of claim and evidence are reversed: the ground truth response becomes the claim, while the generated response becomes the evidence. For example, a ground truth response and a generated response are input to alignment scorer 160, which outputs a single score.

A sufficiency score is generated for each generated response and, therefore, a sufficiency score may be generated for each generated response of multiple generated responses. Then, the sufficiency scores may be aggregated in one or more ways to generate an overall sufficiency score for the response generator, which may be Q&A system 120. Example aggregation operations that may be performed on a set of sufficiency scores include minimum, maximum, median, mean, and one or more percentiles.

Generating ground truth (or expected) responses manually may be an expensive and tedious task. Therefore, in a related embodiment, a response generation system (e.g., Q&A system 120) is used to generate an initial response and a human user verifies that claims in the initial response have support in the supporting documents, making any necessary modifications to that initial response based on the supporting documents, resulting in a ground truth response. Repeating this process for multiple responses may result in some ground truth responses being based on one or more human user modifications and other ground truth responses being based on no human user modifications (although manually verified). In other words, different ground truth responses may have different amounts of human user modifications.

Regarding the truthfulness metric, this metric signals how well the generated response is grounded in a set of documents, which represents the ground truth. For example, a Q&A system using the RAG pattern and an LLM to generate text responses may still generate the correct response even if the retrieved documents are not the expected ones if the LLM has been trained on the data from which the Q&A system is meant to provide responses. This truthfulness metric allows for checking the factual consistency of the response without the effect of the information retrieval (IR) system and evaluating the responses even in the lack of IR, for fine-tuned LLMs on specific customer data. Thus, the truthfulness metric is a measure of the accuracy of the Q&A system, or the source of generated responses. Again, a truthfulness score may be computed by alignment scorer 160 by inputting a generated response and a ground truth document (or a set of ground truth documents).

The process of identifying ground truth documents may be a purely manual process or may be system-assisted. For example, an LLM may be used to identify a set of possible documents pertaining to a prompt (which may be what a generated response is based on) or a set of one or more keywords. Thereafter, a user selects which document in the set of possible documents should be considered ground truth documents against which the truthfulness metric is calculated. Again, a different truthfulness score may be generated for each generated response of multiple generated responses. Thereafter, an aggregated truthfulness score may be generated based on the multiple truthfulness scores, the aggregated score representing an accuracy of the response generator, such as Q&A system 120. Example aggregations that may be performed on a set of truthfulness scores include minimum, maximum, median, mean, and one or more percentiles.

Embodiments have resulted in matching estimations of human evaluators for 84% of responses. In contrast, a prior approach only correctly scored 52% of responses.

### Embodiment Combinations

Numerous embodiments have been described herein. Some embodiments involve all components of system architecture 100 while other embodiments involve only a subset of components of system architecture 100. For example, claims processor 140 may perform one of the novel techniques described herein for claims processor 140 while evidence processor 150 does not exist and online metrics generator 170 only generates a single alignment score for each claim or for the entire response from Q&A system 120. As another example, claims processor 140 is a traditional claims processor while evidence processor 150 performs one of the novel techniques described herein for evidence processor 150.

### Use Cases

Instead of Q&A system 120 generating responses that are analyzed by other components of system architecture 100, other sources of responses may be used. For example, a user may provide oral statements that are analyzed by claims processor 140, while knowledge base 130 and evidence processor 150 are used to identify and process documents that are determined to be relevant to the subject matter of the oral statements (or a question that prompted the oral statements). The claims identified by claims processor 140 and the pieces of evidence generated by evidence processor 150 are input to alignment scorer 160, which generates scores that are input to online metrics generator 170.

As a specific example, a computing device records a person speaking (e.g., live, in person; through a television; through a live stream over the Internet; through a phone; etc.) and the computing device (or another component in system architecture 100) converts that analog audio from the speaking to digital audio data. (The person may be a salesperson, a candidate running for political office, a news commentator, a celebrity, a teacher, etc.) A component (e.g., not depicted) in system architecture 100 analyzes the digital audio data and converts the digital audio data to digital text data, which is then input to claims processor 140. Another component (e.g., not depicted) in system architecture 100 identifies one or more documents in knowledge base 130 that are determined to be relevant to the subject matter reflected in the digital text data.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

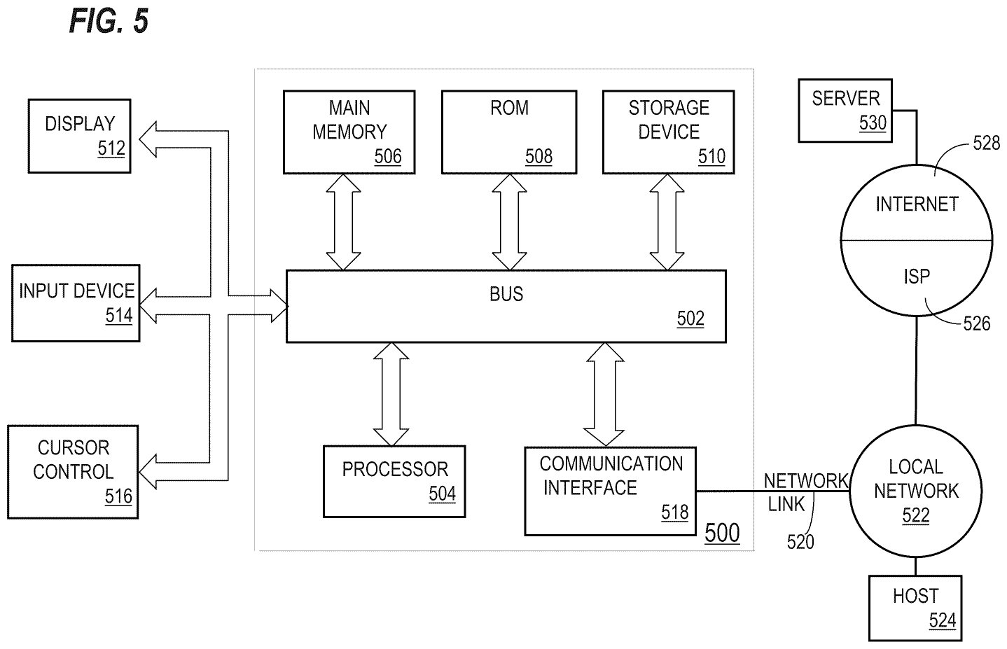

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

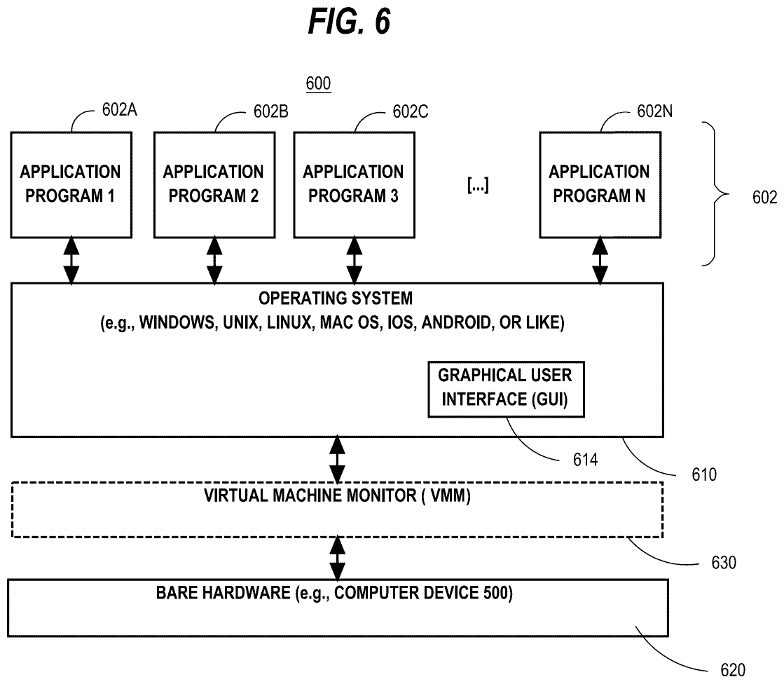

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying text data;
identifying, within the text data, a list of items and introductory text that is associated with the list of items;
for each item in the list of items:
generating a claim that is based on the introductory text and said each item;
adding the claim to a set of claims that is associated with the text data;
for each claim in the set of claims:
generating a score that reflects a level of support of said each claim in a set of documents;
adding the score to a set of scores for the set of claims;
causing, to be presented on a screen of a computing device, data that is based on the set of scores;
wherein the method is performed by one or more computing devices.

2. The method of claim 1, wherein the text data was generated by a question and answer computer system.

3. The method of claim 1, further comprising:
identifying, within the text data, a pronoun;
identifying, within the text data, one or more nouns upon which the pronoun is based;
prior to dividing the text data into sentences, replacing the pronoun with the one or more nouns.

4. The method of claim 1, wherein the list of items is a numbered list, further comprising:
prior to generating the score for each claim in the set of claims, removing each number that precedes an item in the list of items.

5. The method of claim 1, wherein the list of items is within a sentence of the text data and is a flattened list, further comprising:
determining that the list of items is a flattened list based on a number of commas or based on a number of phrases separated by commas in the sentence.

6. The method of claim 1, further comprising:
identifying one or more filler sentences in the text data;
removing the one or more filler sentences from consideration when generating a particular score for the text data.

7. The method of claim 1, further comprising:
identifying, within the text data, a sentence that refers to the second person;
in response to identifying the sentence, identifying a question that is associated with the sentence;
generating a new sentence that is based on the sentence and the question;
generating a particular score for the text data that is based on the new sentence.

8. The method of claim 1, further comprising:
for each score of the set of scores:
mapping said each score to a range of values from among a plurality of ranges of values;
identifying a label that is associated with the range of values;
assigning the label to the claim that corresponds to said each score,
wherein the data is also based on the label of each claim in the set of claims.

9. The method of claim 1, further comprising:
based on the text data, identifying a plurality of claims that includes the set of claims;
wherein each claim in the plurality of claims is associated with a different score of a plurality of scores that includes the set of scores;
identifying a minimum score from the plurality of scores;
assigning, to the text data, the minimum score as a grounding score.

10. The method of claim 1, further comprising:
based on the text data, identifying a plurality of claims that includes the set of claims;
wherein each claim in the plurality of claims is associated with a different score of a plurality of scores that includes the set of scores;
computing a mean score from the plurality of scores;
assigning, to the text data, the mean score as a grounding score.

11. The method of claim 1, further comprising:
based on the text data, identifying a plurality of claims that includes the set of claims;
wherein each claim in the plurality of claims is associated with a different score of a plurality of scores that includes the set of scores;
identifying a minimum score from the plurality of scores;
mapping minimum score to a range of values from among a plurality of ranges of values;
identifying a label that is associated with the range of values;
assigning, to the text data, the label as a grounding label.

12. The method of claim 1, further comprising:
based on the text data, identifying a plurality of claims that includes the set of claims;
wherein each claim in the plurality of claims is associated with a different score of a plurality of scores that includes the set of scores;
for each score of the plurality of scores:
mapping said each score to a range of values from among a plurality of ranges of values;
identifying a label that is associated with the range of values;
assigning the label to the claim that corresponds to said each score;
including the label in a set of labels;
determining a number of labels, in the set of labels, that indicate that the claim that corresponds to the label is grounded;
based on the number of labels, determining a ratio of the number of labels to a particular number of labels that are in the set of labels;
assigning, to the text data, the ratio as a grounding score.

13. A method comprising:
identifying text data that was output by a question and answer computer system based on a prompt and a plurality of documents;
identifying a set of claims within the text data;
generating a combination of the plurality of documents, wherein the combination is based on two or more documents in the plurality of documents;
for each claim in the set of claims:
generating, for said each claim, a score that reflects a level of support of said each claim in the combination;
adding the score to a set of scores for said each claim;
causing data to be presented on a screen of a computing device based on the set of scores;
wherein the method is performed by one or more computing devices.

14. The method of claim 13, further comprising:
generating a plurality of groupings of the plurality of documents;
wherein the combination is a grouping in the plurality of groupings;
wherein generating the score is performed for each grouping of the plurality of groupings, wherein the score for said each claim reflects a level of support of said each claim in said each grouping.

15. The method of claim 14, wherein each grouping in the plurality of groupings comprises less than all of the plurality of documents.

16. The method of claim 14, wherein generating the plurality of groupings comprises:
determining that total size of the plurality of documents is greater than a predefined threshold;
creating a plurality of new combinations from the plurality of documents, wherein a first new combination in the plurality of new combinations is created by removing one of the plurality of documents, wherein a second new combination in the plurality of new combinations is created by removing another one of the plurality of documents;
for each combination in the plurality of new combinations:
determining whether said each combination exceeds the predefined threshold;
if said each combination exceeds the predefined threshold, then adding said each new combination to an OVER_THE_LIMIT set;
if said each combination does not exceed the predefined threshold, then adding said each new combination to the plurality of groupings.

17. The method of claim 16, further comprising, for each combination in the OVER_THE_LIMIT set:
creating one or more new particular combinations from said each combination;
for each new particular combination in the one or more new particular combinations:
determining whether said each new particular combination exceeds the predefined threshold;
if said each new particular combination exceeds the predefined threshold, then adding said each new particular combination to the OVER_THE_LIMIT set;
if said each new particular combination does not exceed the predefined threshold, then adding said each new particular combination to the plurality of groupings.

18. The method of claim 13, further comprising:
prior to generating the score, determining whether a size of the combination is less than a predefined threshold;
wherein generating the score is only performed in response to determining that the size of the combination is less than the predefined threshold.

19. One or more non-transitory storage media storing instructions which, when executed by one or more computing devices, cause performance of the method recited in claim 1.

20. One or more non-transitory storage media storing instructions which, when executed by one or more computing devices, cause performance of the method recited in claim 13.
